(19) United States
(12) Patent Application Publication
(10) Pub. No.: US 2003/0103761 A1
(43) Pub. Date: Jun. 5, 2003

(54) Folded light path for planar optical devices

(76) Inventors: Yee Loy Lam, Singapore (SG); Yuen Chuen Chan, Singapore (SG); Seng Lee Ng, Singapore (SG); Jingang Liu, Singapore (SG)

Correspondence Address: BUCKLEY, MASCHOFF, TALWALKAR, & ALLISON, 5 ELM STREET, NEW CANAAN, CT, 06840, US

(21) Appl. No.: 10/267,116

(22) Filed: Oct. 8, 2002

(30) Foreign Application Priority Data
Oct. 9, 2001 (GB) 0124218.9

(51) Int. Cl. G02B 6/10

(52) U.S. Cl. 385/146; 385/39; 385/129

(57) ABSTRACT

There is provide an optical device comprising a planar structure adapted so that light coupled into an optical layer of the device follows a folded optical path, thereby increasing the interaction length, wherein the folded optical path is substantially perpendicular to the planar structure so as to render the optical device substantially polarization insensitive. Typically, the folded path is achieved by modifying at least one of an upper surface of the optical layer and a lower surface of the optical layer such that it is no longer planar, but instead comprises one or more angled facets.

### FIELD OF THE INVENTION

The present invention relates to folded pathways for light propagation in optical and optoelectronic devices.

### BACKGROUND TO THE INVENTION

Confinement of light in planar non-fibre based optical and optoelectronic devices is generally achieved through waveguide structures, where a region of higher refractive index than its surroundings act as a light guide. Such waveguide structures have been demonstrated in silica-on-silicon as well as in III-V compound semiconductors. Almost all the devices which are currently used in optical communication systems are based upon this planar waveguide structure. These include active devices, such as laser diodes, modulators, optical amplifiers and detectors, and also passive devices such as Y-branches, couplers, tapers, and arrayed waveguide gratings.

When the direction of light propagation out of an active device is not orthogonal to the layers of the device structure, the device is usually said to be edge emitting. Due to the waveguide geometry of such devices, the light emitted is often in the form of an elliptical and astigmatic beam. Coupling such beams into circularly symmetric fibres is therefore difficult and lossy, without the use of beam shaping elements.

A further problem associated with devices based upon the planar waveguide structure, is the strong differential sensitivity to the transverse electric (TE) and transverse magnetic (TM) polarized modes of the waveguide. This polarization sensitivity can lead to a degradation in performance when both types of mode are present, as is often the case when the optical beam is derives from a non-polarization maintaining optical fibre. In order to minimize the effect, it is important that a plane wave-front propagating along the waveguide structure experiences a two-dimensional transverse refractive index symmetry. However, due to the geometric configuration of many waveguide structures, the TE and TM modes experience differences in the symmetry of the refractive index variation, leading to a birefringence effect.

In addition to waveguide birefringence, there are other sources of differential polarization sensitivity that can arise In optoelectronic devices when the direction of light propagation is not orthogonal to the layers of the device structure. For example, if an active region in an optoelectronic device includes quantum well structures to enhance the device performance, polarization sensitivity also arises because of the different dependence of the heavy and light hole band transitions on TE and TM polarized light. This stems from the fact that TE polarized light interacts with both heavy and light hole valence bands whereas TM polarized light interacts with only the higher energy light hole bands. Attempts have been made to reduce or eliminate this polarization dependence by bandgap engineering, whereby tensile stress is built into the quantum well structure to align the heavy and light hole levels. However, this alignment can only be achieved at one wavelength and is therefore not a solution when wide-band operation is required.

Polarization sensitivity is a particular problem for active devices such as optical amplifiers and modulators, which are key components in a high speed optical network. The erbium-doped fibre amplifier (EDFA) is widely used in multi-wavelength, high-data rate transmission systems, but suffers from undesirable gain transients in a switched mode of operation. Raman amplification is also being considered for broadband long haul systems. However, due to the complexity and cost of these two approaches, the semiconductor optical amplifier (SOA) continues to progress as a potentially more compact and less expensive alternative, which can be integrated with other devices. However, the SOA not only suffers from the waveguide birefringence described above but also a gain birefringence, whereby TE and TM modes experience a different amplification. These problems are further exacerbated by the inclusion of quantum well structures with their associated polarization sensitivity. The same problems apply to optical modulators such as electro-absorption modulators, particularly those based on quantum well structures.

An alternative configuration for light confinement, which avoids many of the problems discussed so far, is based on a vertical cavity device structure whereby the light propagates normal to the surface of the layers. In this case, a more symmetric beam shape can be obtained from the device, easing the problem of coupling the light into an optical fibre. Also, both TE and TM modes are optically confined such that their polarization vectors lie in a plane that is perpendicular to the direction of propagation, thereby experiencing perfect symmetry in the refractive index profile. As a result, there is no refractive index birefringence. Furthermore, the differential polarization dependence of band transitions in quantum well devices can be avoided.

However, a problem arises in such active vertical cavity devices because the active region is limited in thickness to at most several microns, due to difficulties posed by the epitaxial growth process. As a consequence of the short interaction length, the gain or absorption that can be achieved from a single pass in such devices is limited to a relatively low level.

A common approach to increasing the interaction length in vertical cavity devices is to arrange for the light to experience multiple passes of the interaction region. This can be achieved by incorporating mirrors into one or more of the layers located above or below the active region. These mirrors typically comprise a semiconductor distributed Bragg reflector (DBR) or a metallic layer. The light transmittance of a DBR can be controlled by its structure, but it is known to be difficult to achieve a high reflectivity DBR at 1.55 um using materials such as indium phosphide (InP). Furthermore, the DBR is a wavelength sensitive structure and therefore not suitable for broadband or tunable operation. Metal layers offer a more uniform wavelength response but tend to be characterized by a high reflectivity, making it difficult to obtain sufficient transmission of light to the next stage of the device.

Thus, a solution is required to the problem of fabricating planar optical and optoelectronic devices which are polarization insensitive and broadband in operation and, for some of the devices, also retain the length of interaction region necessary for efficient operation.

### SUMMARY OF THE INVENTION

According to the present invention, an optical device comprises a planar optical structure adapted so that light coupled into an optical layer of the device follows a folded optical path, thereby increasing the interaction length, wherein the folded optical path is substantially perpendicular to the planar structure so as to render the device substantially polarization insensitive.

The folded path is achieved by modifying at least one of an upper surface of the optical layer and a lower surface of the optical layer such that it is no longer planar, but instead comprises one or more angled facets. The upper and lower surfaces of the optical layer may comprise a plurality of parallel trenches whose sides are angled to form the facets. Of course, more complicated structures can be contrived, including a series of pits with sides angled to form the facets.

Preferably. at least one of an upper surface of the optical layer and a lower surface of the optical layer comprises one or more trenches or pits with angled facets. More preferably, both the upper surface of the optical layer and the lower surface of the optical layer comprise one or more trenches or pits with one or more angled facets.

By undergoing reflection at said facets, an optical beam can traverse the length of the planar structure whilst having a propagation direction that is substantially perpendicular to the layer structure of the planar device for a substantial portion of the total optical path traversed.

Preferably, the facts are substantially reflecting.

Preferably, the dimensions of the planar optical device, and the angles and locations of the facets are such that an optical beam propagating by reflection from the facets will traverse the length of the planar optical device. More preferably, the dimensions of the planar optical device, and the angles and locations of the facets are such that an optical beam propagating by reflection from the facets will traverse the length of the planar optical device via an optical path, a substantial part of which has the beam propagation direction substantially perpendicular to the layers of the planar optical device.

Depending upon the ratio of optical layer thickness to device length, such optical paths will typically compose many folds, whereby the light beam traverses the vertical dimension of the optical layer many times. In this way, not only can a long optical path length be realized, but also the optical beam direction can be substantially perpendicular to the layers of the structure for much of the path.

Thus, for much of the path, the polarization vector of the optical beam lies in a plane which is parallel to the layers of the device structure, thereby experiencing refractive index symmetry and minimizing birefringence. Furthermore, if the optical layer that the light interacts with is active, as in a modulator, SOA or laser for example, then gain or absorption birefringence can be avoided. If the active layer includes layered quantum well structures, for enhanced performance, the problem of band transition polarization sensitivity is also circumvented. There are, therefore, many optical devices that may be rendered substantially polarization insensitive by use of a folded light path.

The increased interaction length that can be achieved using a folded light path also offers the potential for novel devices with improved performance. In particular, folded pathways can be used to realize efficient vertical cavity type structures, such as the vertical cavity amplifier (VCA) or vertical cavity surface-emitting laser (VCSEL). In this way a more symmetrical beam shape, typically associated with vertical emitting laser (VEL) structures can be obtained without compromising gain length and extraction efficiency. Such beams are desirable for low-loss coupling to optical fibres.

Of course, the optical device may comprise a planar waveguide structure, in which case the optical layer along which light is propagating may comprise the higher refractive index core of a planar waveguide. The upper and lower surfaces of the optical layer that are adapted may then comprise the interfaces between the core layer and an upper and lower cladding layer, respectively.

### BRIEF DESCRIPTION OF THE DRAWINGS

Examples of the present invention will now be described in detail with reference to the accompanying drawings, in which.

FIG. 1 is an example of an edge-emitting planar waveguide structure;

FIG. 2 is an example of a vertical-emitting planar optical structure;

FIG. 3A shows an example of an optical device with a folded light pathway in a planar optical structure, in accordance with the present invention:

FIG. 3B shows an exploded schematic of a v-groove mirror pair from FIG. 3A;

FIGS. 4A, 4B and 4C show a first configuration for a folded pathway in a crystalline substrate;

FIG. 5 is a 3-D perspective of the pathway shown in FIG. 4A;

FIGS. 6A and 6B show a second configuration for a folded pathway in a crystalline substrate;

FIG. 7 is a 3-D perspective of the pathway shown in FIG. 6A;

FIGS. 8A and 8B show a third configuration for a folded pathway in a crystalline substrate;

FIG. 9 shows the optical coupling of folded pathway devices;

FIG. 10 shows an edge emitting device with a folded pathway.

FIG. 11 shows the optical excitation of a device with a folded pathway;

FIG. 12 is a graph of amplified output versus pump power for an SOA;

FIG. 13 shows a VEL with folded pathway; and,

FIG. 14 shows a tunable VEL with folded pathway.

### DETAILED DESCRIPTION

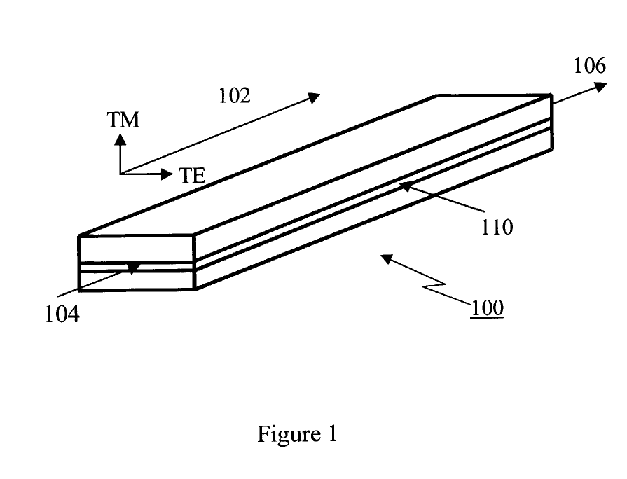

FIG. 1 shows an example of a typical edge-emitting planar waveguide structure 100 currently in use and also the polarization directions for TE and TM polarized light. It is clear that only TE polarized light has its polarization vector lying in a plane that is parallel to the layers of the structure. Light of mixed polarization state will experience refractive index birefringence.

In FIG. 1, light enters the structure at an input end 104, propagates along an active region 110 in a direction 102 orthogonal to both TE and TM modes and then leaves the structure at an output port 106.

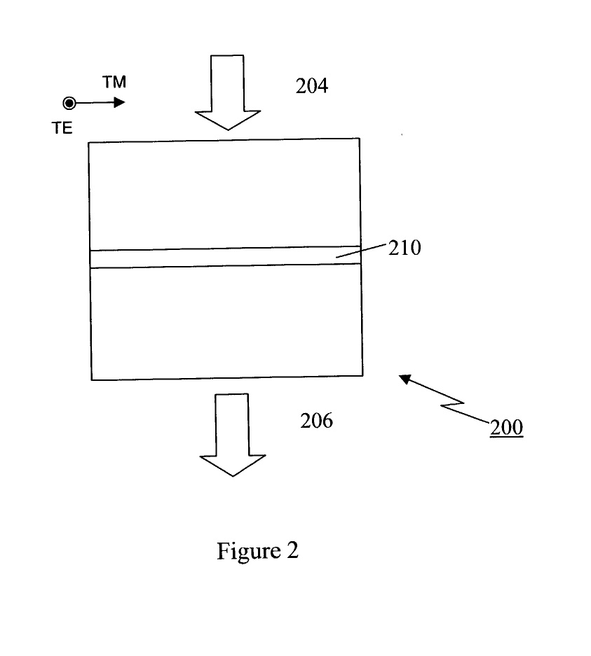

FIG. 2 shows an example of the alternative vertical-emitting planar structure 200 currently in use and also the polarization directions for TE and TM polarized light. It is clear that in this configuration, the polarization vector of both TE and TM polarized light lies in a plane that is parallel to the layers of the structure. Light of mixed polarization state will not experience refractive index birefringence, but neither will the light experience a significant optical path in the optical region of the device. This reduces the effect of amplification or absorption in the region.

In FIG. 2, light enters the structure at an input end 204, propagates via an active region 210 in a direction orthogonal to both TE and TM modes and then leaves the structure at an output port 206.

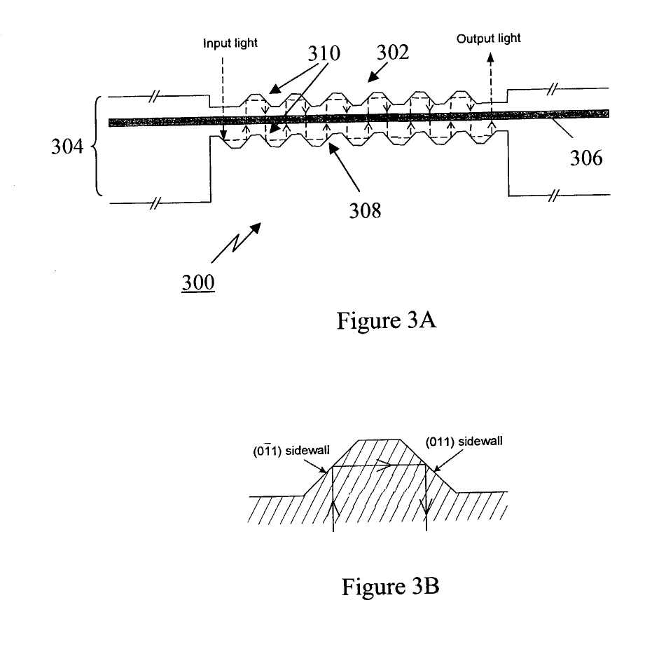

FIG. 3A shows a schematic of a folded light pathway 302 in an optical layer 304 of a planar optical structure 300, in accordance with one aspect of the present invention. Here, the optical layer 304 contains an active region 306 which may be either a bulk region or a multiple quantum well (MOW) region. The folded light path 302 is achieved by incorporating a periodic structure 310 at the upper and lower surfaces of the optical layer, which comprises a series of v-grooves, or angled facets 308. The facets act as turning mirrors oriented at 45° to the incident light. Consequently, the light beam is turned through 90° by each mirror and by 180° by each mirror pair.

In this example the light is incident perpendicular to the layered structure and, after experiencing an even number of reflections, emerges perpendicular to the layered structure. Indeed, in this example, the light experiences reflection at an even number of mirror pairs and therefore emerges from the structure in a direction that is parallel to, but rotated 180° from, the direction of incidence. As the light propagates from one end of the planar optical structure to the other, its direction, for much of the optical path, is parallel to or rotated 180° from the incidence direction, i.e. perpendicular to the layers of the planar optical structure. Therefore, the effects of polarization sensitivity can be substantially mitigated, whilst maintaining a long potential interaction length.

Of course, many variations on the basic design shown in FIG. 3 are possible, including facets which are oriented to reflect at other angles. The precise form of the reflecting features that can be achieved will typically depend upon the crystalline structure and etching properties of the semiconducting or other material used to fabricate the planar optical device.

To achieve the type of beam path illustrated in FIG. 3, a plurality of v-groove mirrors must be fabricated at the upper and lower (surfaces of the ) optical layer, that are above and below the active layer respectively, by etching the material to obtain the required facets. Based on the crystal growth direction [001] of an indium phosphide (InP) substrate, the v-groove mirror pair can be obtained by wet etching to expose the crystal planes (011) and (011), as shown in the exploded schematic FIG. 3B. It is possible to expose these planes because of wet etch selectivity in the specified directions.

Using wet etching of InP substrates, there are at least three possible reflecting configurations to direct the beams in a folded zigzag manner. These three configurations involve three different designs for an array of angled reflecting facets in the tipper and lower optical layers.

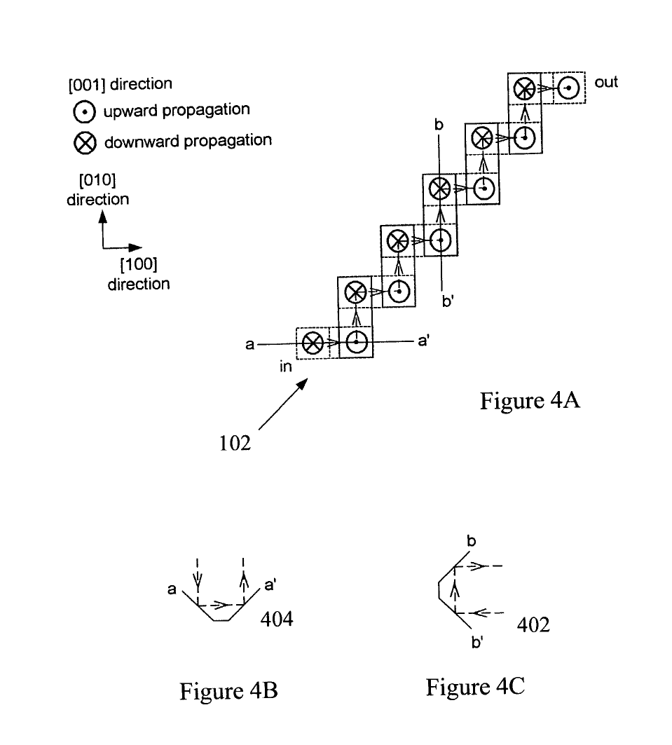

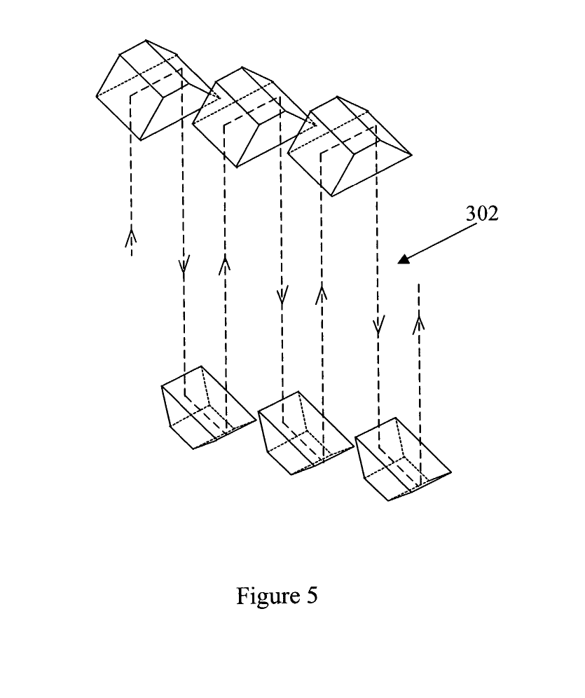

FIG. 4A illustrates the first embodiment in which a light beam is incident perpendicular to the planar optical structure 300. The light propagation path is indicated with respect to the crystal plane directions. The reflecting facets 308, which form the v-groove mirrors, are fabricated by wet etching along the crystal planes and, due to the atomic bonds on the surfaces of the III-V semiconductor wafer, those on the upper optical layer 402 are oriented at 90° to those on the lower layer 404 (See FIGS. 4B and 4C). Each v-groove mirror pair is localized in a rectangular pit, and these pits are regularly spaced apart. After reflection at a lower and upper mirror pair, the light beam has experienced two orthogonal transverse displacements and two equal but opposite vertical displacements. Thus, as the array of v-groove mirror pits in the upper and lower optical layers share the same periodicity, the average or resultant direction of the light propagation with respect to the crystalline structure of the wafer is either [110] or [110]. FIG. 5 illustrates the folded pathway 302 more clearly in a 3-D representation.

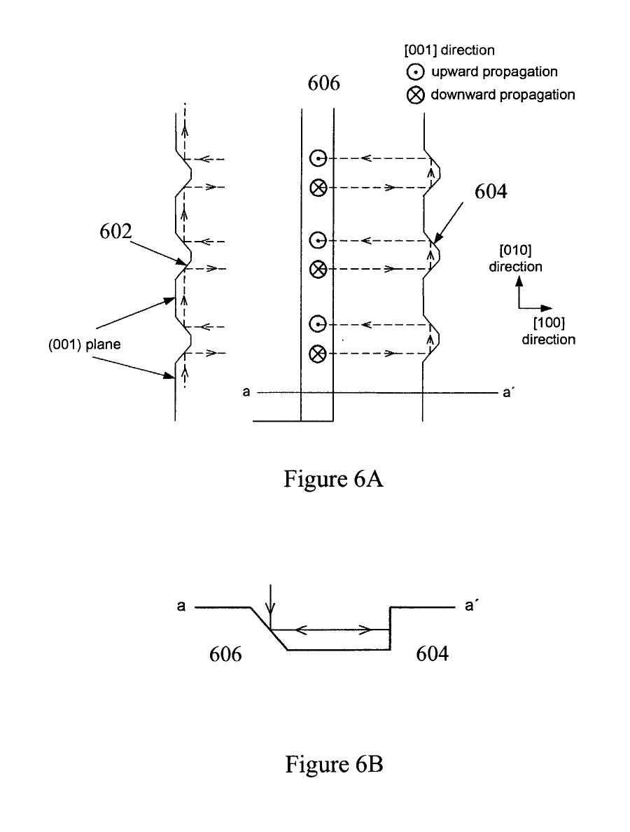

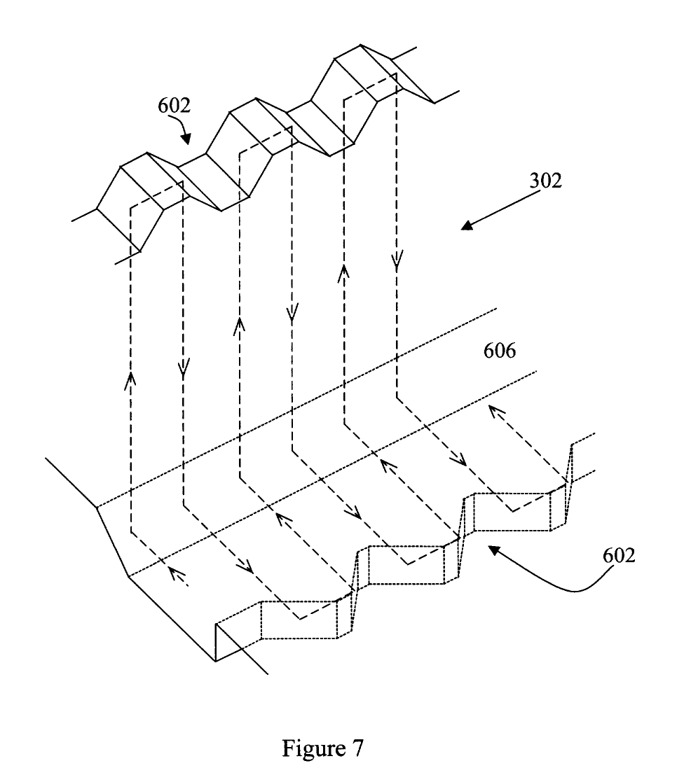

A second embodiment of the InP-based structure is shown in FIG. 6A. Here, the upper layer etched mirrors 602 are based on a series of v-grooves that are arranged in a linear array, while the lower layer reflectors comprise a more complex trench. One side wall of the trench 606 comprises a uniform 45° slope with respect to the wafer surface, which can be achieved by means of a wet etching process. The opposing side wall 604 of the trench is vertical, 90° with respect to the wafer surface and crenellated. The crenellations comprise identical v-grooves to those an the upper optical layer 602 and have the same periodicity. These vertically etched mirrors 604 are in the [001] crystal growth direction and can be achieved by means of dry etching. A cross-section aa′ through the trench in the lower optical layer, is shown in FIG. 6B, clearly indicating the orientation of the side walls in this embodiment, after a double pass of the active layer, a light beam has experienced two equal but opposite [001] vertical displacements, two equal but opposite [100] horizontal displacements and two equal [010] horizontal displacements. Thus the average or resultant direction of the light propagation [010] with respect to the crystalline structure of the wafer. FIG. 7 shows a 3-D representation of the path 302 folded in this embodiment.

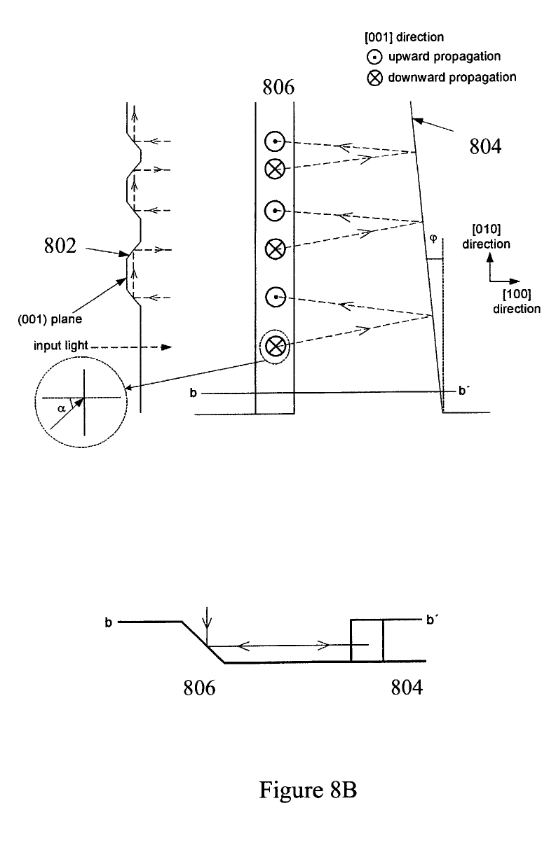

FIG. 8 illustrates the third embodiment of the InP-based structure. The structure is quite similar to that of FIG. 6, but with two key differences. The second side wall 804 of the trench in the lower optical layer is no longer crenellated but is a vertical planar surface inclined at an angle φ with respect to the [010] crystal direction. This feature can be fabricated by means of a dry etching process. A second difference to FIG. 6 is that the v-groove mirror 802 pairs in the upper optical layer are not periodically spaced. This is so because in this embodiment, the input light is not incident perpendicular to the device structure but enters at an angle of α. Consequently, as the light transverses the structure, the horizontal distance travelled between each individual mirror pit on the upper surface becomes smaller then the light is propagating in the [010] direction where the separation between the sloped side wall of the trench 806 and the vertical planar surface 804 on the lower optical layer decreases. A cross-section bb′ through the trench in the lower optical layer, is shown in FIG. 8B, indicating how the trench differs from that of FIG. 6.

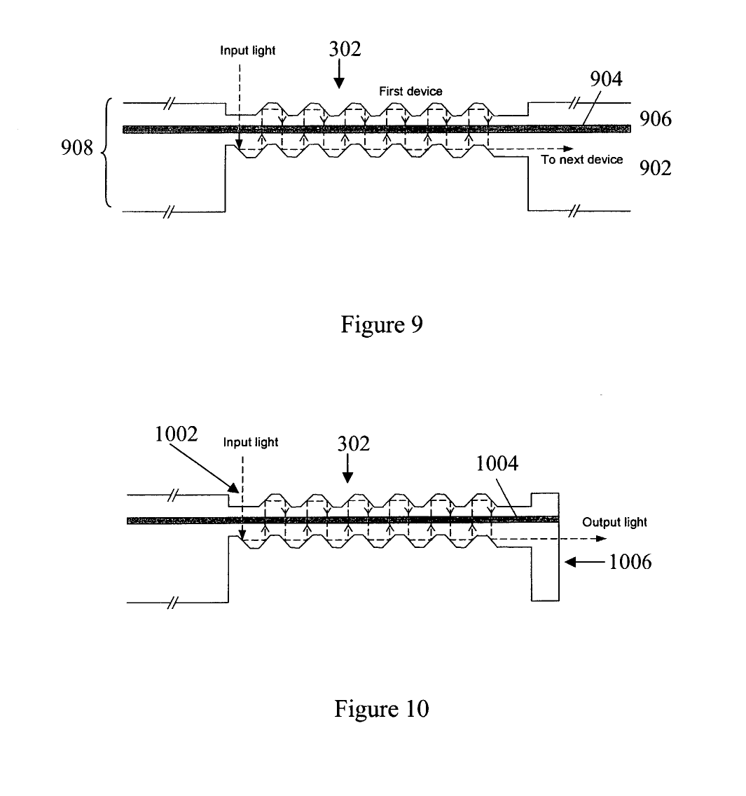

The folded light pathways 302 described hereto can be used to link active or passive devices together to form functional photonic integrated circuits. The light can be guided directly from one device to another via a continuous folded path 302. Alternatively, as shown in FIG. 9, the light wave can propagate from one device to another, over a short distance of several microns, via a section of the upper 906 or lower surface 902 of the optical layer 908 without being channelled into the active region 904. This optical layer 908 is usually transparent to light at the operating wavelength, thereby providing an inherently low-loss path for integration purposes. Consequently, low-loss photonic integration can be achieved without the need for bandgap engineering or regrowth steps, either through propagation along a continuous folded path 302 or via an optical layer 908.

The folded light pathway 302 provided in the present invention can be used as the light guiding mechanism in many optoelectronic devices, such as the optical amplifier, optical modulator, variable optical attenuator and laser diode. FIG. 10 shows an example of an optical device (with folded light path) where light is coupled in through a surface facet 1002 and exits the device via an edge facet 1006. In such devices, the layer 1004 that the light interacts with will typically be active, with external optical or electronic control or excitation. The necessary active interaction length is then provided by the folded pathway 302 and is predominantly at 90° to the layers of the device structure. This circumvents problems with polarization dependent gain and absorption, or polarization dependent hole band transitions in quantum well structures. As the reflecting structure is made up primarily of 45° facet reflectors and/or vertical facet reflectors, which are essentially broadband, the device will be substantially polarization insensitivity over a range of wavelengths of interest.

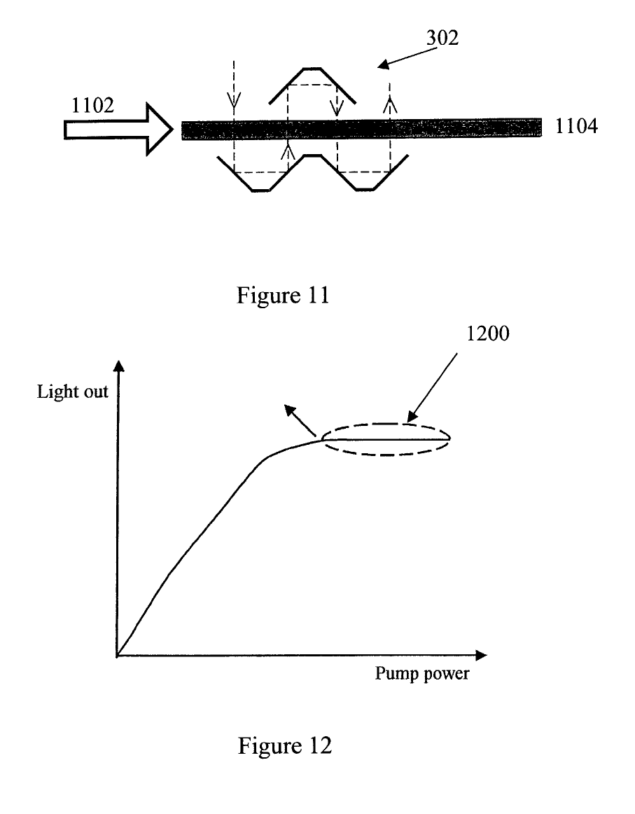

For the case of a semiconductor optical amplifier (SOA), the folded propagation path 302 of the input light allows for large and polarization insensitive gain, which is provided for by current injection through the active layer. Meanwhile, for gain-clamped or linearly amplifying operation, the planar optical device can be designed to be a waveguide structure and the active layer 1104 would be optically excited by guiding a pumped light 1102 into the active layer along the waveguide direction, as shown in FIG. 11. This pump light 1102 serves to pre-bias the gain to the saturation region 1200 for gain-clamping as shown in the graph of FIG. 12, thereby ensuring linear optical amplification.

For the case of an optical modulator light which propagates perpendicular to the layer structure for much of the folded path, also propagates parallel to the applied electric field which drives the modulator. This parallel configuration allows for a better interaction between the light wave and electric field, and the performance of the optical modulator is expected to be enhanced. By employing large signal control of the optical modulator, the device can function as a variable optical attenuator (VOA) with very low polarization dependency.

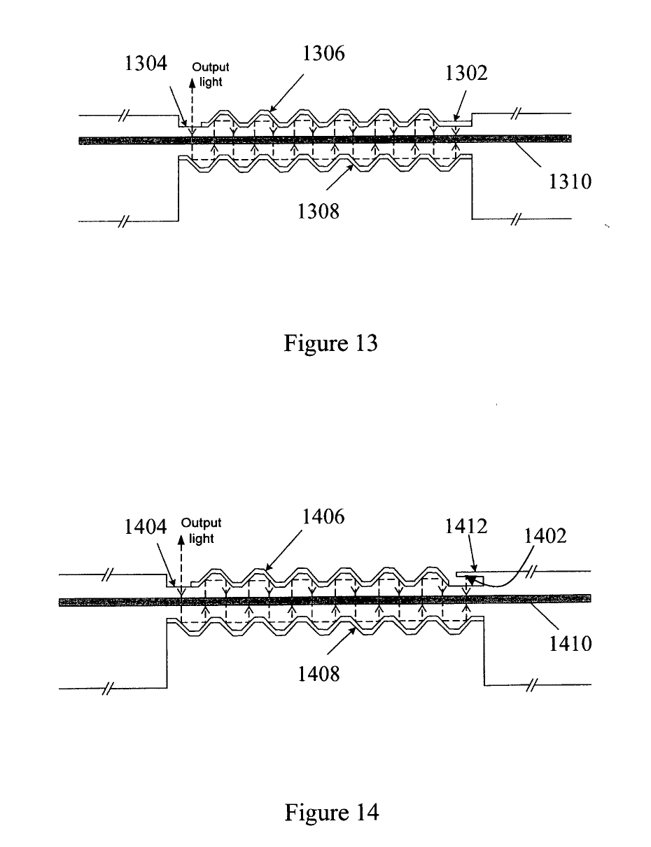

A vertically emitting laser (VEL) structure can also be realized using folded light paths, according to one aspect of the present invention. A schematic of such a device is shown in FIG. 13. The cavity is formed by reflective facets 1302, 1304 which terminate the two ends of the folded light path 302. These end mirrors may comprise a Fresnel reflection at a optical layer-air interface, or the facets could be coated with metal or dielectric films to enhance the reflectivity. By tailoring the reflectivity at both the reflecting ports, it is possible to have either a single output port 1304, as shown in FIG. 13, or dual output ports. The dual output port configuration is advantageous for applications where two separate but mutually coherent optical beams are required. The device can be pumped by either current injection through the metal electrodes 1306, 1308 on the upper and lower surfaces of the optical layer, at locations which do not impact on the internal reflections, or by optical excitation, In the manner shown in FIG. 9.

It is noted that, although light inside the laser cavity traverses the active layer 1310 many times, each section of the folded path occupies a different localized region of the active layer. This results in a large gain volume for greater energy storage, and saturation of the gain will occur only at higher power levels leading to a greater potential output. In addition, by spreading the gain over a larger volume, as compared to a conventional vertical cavity surface emitting laser (VCSEL), the proposed VEL is expected to suffer less from thermal effects as any heat generated is spread over a larger area. The heat dissipation can be further enhanced by a thick layer of gold, which may also act as an electrode for current injection.

The proposed device also benefits from other advantageous features associated with a VEL. The optical output of the device can be substantially symmetrical, which facilitates efficient coupling of the light to an optical fibre. By virtue of the vertical emission, on-wafer testing of the device is possible, prior to the dicing up of individual devices an the wafer.

In a further enhancement of the VEL, one or both of the potential output ports can be fabricated with a movable micro-electrical-mechanical (MEM) cantiliever 1412, as shown in FIG. 14. The partially or wholly reflecting facets 1402, 1404, which provide optical feedback to the cavity, can be mounted on said cantilevers 1412. Controlled motion of the micro-cantilevers can be achieved by application of an electric field. This, by a small movement in the position of a reflecting facet 1402 mounted on the cantilever 1412, the length of the optical cavity can be adjusted. This permits tuning of the emission wavelength of the laser and, with an appropriate error signal supplied to the controlling electronics, frequency stabilization may be achieved.

As for FIG. 13, light inside the laser cavity traverses the active layer 1410 many times and each section of the folded path occupies a different localized region of the active layer.

Therefore, in accordance with one aspect of the present invention, a folded light path within a conventional planar optical structure provides a long optical path, within the structure, that is substantially polarization insensitive. These features permit the construction of a wide range of optical and optoelectronic devices with superior performance. In particular, the problem of polarization sensitivity can be substantially mitigated by maintaining the polarization vector of the light parallel to the layers of the device structure for much of the optical path. Furthermore, a novel type of vertical emitting laser (VEL) can be realized using a folded light path, which combines the benefits of vertical emission with the more efficient operation associated with edge-emitting devices.

1. An optical device comprising a planar structure adapted so that light coupled into an optical layer of the device follows a folded optical path, thereby increasing the interaction length, wherein the folded optical path is substantially perpendicular to the planar structure so as to render the optical device substantially polarization insensitive.

2. An optical device according to claim 1, in which the planar structure is adapted so that at least one of an upper surface and a lower surface of the optical layer comprises a plurality of reflective angled facets.

3. An optical device according to claim 1, in which the planar structure is adapted so that at least one of an upper surface and a lower surface of the optical layer includes a pit, one or more side walls of the pit comprising a reflective angled facet.

4. An optical device according to claim 1, in which the planar structure is adapted so that at least one of an upper surface and a lower surface of the optical layer includes a trench, one or more side walls of the trench comprising a reflective angled facet.

5. An optical device according to any of claims 2 to 4, in which the or each reflective facet is disposed at an angle that is substantially 45° to the planar structure.

6. An optical device according to claim 5, in which adjacent reflective facets are substantially perpendicularly disposed.

7. An optical device according to claim 4, in which a side wall of the trench includes a pit, in which one or more side walls of the pit comprise a reflective angled facet.

8. An optical device according to claim 7, in which the reflective facet is disposed at an angle that is substantially 45° to the trench.

9. An optical device according to claim 8, in which adjacent reflective facets are substantially perpendicularly disposed.

10. An optical device according to any of claims 2 to 9, in which a reflective facet is formed by etching to expose a crystal plane.

11. An optical device according to any preceding claim, in which the optical layer comprises the core of a planar waveguide within the planar structure of the device.

12. An optical device according to any preceding claim, wherein the optical device contains a quantum well structure.

13. An optical device according to any preceding claim, wherein the optical device is a laser or laser amplifier.

14. An optical device according to any preceding claim, wherein the optical device is edge emitting.

15. An optical device according to any of claims 1 to 13, wherein the optical device is surface emitting.

16. An optical device according to any preceding claim, wherein the optical device is wavelength tuned by means of a reflector mounted on a micro-cantilever.

17. An optical device according to any preceding claim, wherein the optical device emits two or more co-directional coherent light beams.

18. An optical device according to any preceding claim, wherein at least a portion of a surface of the optical section is coated with a metal layer.
